(19) United States
(12) Patent Application Publication
(10) Pub. No.: US 2009/0205466 A1
(43) Pub. Date: Aug. 20, 2009

(54) Cork extractor

(76) Inventor: Timothy A. Svec, Miami Beach, FL (US)

Correspondence Address: RUBEN ALCOBA, ESQ., 3399 NW 72 AVENUE, SUITE211, MIAMI, FL, 33122, US

(21) Appl. No.: 12/070,417

(22) Filed: Feb. 19, 2008

(51) Int. Cl. B67B 7/06

(52) U.S. Cl. 81/3.2

(57) ABSTRACT

A cork extractor having a plunger, a wire attached to the plunger and an extracting element attached to the wire. The cork extractor is used to remove broken corks from bottles.

### BACKGROUND

The inventor of the present invention is in the food service industry. He trained in one of the best food service industry schools in the country and yet there was one thing that the schools could not teach him: how to insure that every wine opened would not lose the cork within the bottle. The reason is that the schools could not manufacture the corks so that they would not break within the bottles.

This caused the inventor grief, for when he or his waiter colleagues broke a cork within a bottle, they where made to eat the cost of the bottle. This is very taxing on waiters, for bottles of wine are very expensive and their wages are relatively low. On nights that they broke corks within bottles, they in effect worked part of the night for free in order to pay for the costs of the damaged bottles.

The inventor was aware of cork extractors that were made to pull corks from bottles. The devices usually had hooking means to grasp corks from within the bottles. The problem with the extractors is that, like fishing, it takes a certain amount of skill to hook the cork. Another problem with the extractors is that sometimes the hooks damage the corks and leave cork remnants within the wine bottles.

He decided that he had to invent a cork extractor that would pull a cork from within a bottle without having the need of hooking the cork. He also realized that in order to pull the cork from within the bottle he would first have to push the cork within the bottle so that the cork would float on top of the wine. Again, he had to create a device that would push the cork within the bottle that would not damage the cork.

Information relevant to attempt to address these problems can be found in U.S. Pat. Nos. 6,240,808, 5,253,553, 4,679,467, and 3,967,512. However, each one of these references suffers from one or more of the following disadvantages: most of these devices use hooking means to recover the cork or take a great degree of skill to use.

An object of the present invention is to allow a user to pull a damaged cork from within a bottle without leaving remnants within the bottle.

Another object of the present invention is to allow a user of a damaged cork to push the cork within a wine bottle so that the cork can be removed without leaving remnants within the bottle.

A further object of the present invention is to allow waiters not to fear opening a wine bottle.

Still a further object of the present invention is to minimize the costs associated with damaged bottles in the food and wine industry.

For the foregoing reasons, there is a need for a cork extractor that does not use a hooking means to extract the cork.

### SUMMARY

The present invention is directed to a cork extractor that satisfies the need of not using a hook to extract a cork from a wine bottle. The cork extractor comprises a plunger, a wire attached to the plunger and an extracting element attached to the wire. The plunger has a first and a second end, the plunger defining an aperture at an intermediate position substantially towards the first end of the plunger. The wire has a first and a second end, the first end of the wire is placed through the aperture of the plunger and secured to the plunger by attaching a first clasp to the first end of the wire. The first clasp might also attach to a first intermediate position of the wire. The extracting element comprises a plurality of spacers and a plurality of washers, wherein the spacers and washers are placed over the second end of the wire so that the spacers and washers are in the following order, spacer washer spacer washer spacer washer and so forth, the last washer placed over the second end of the wire having a greater diameter than the other washers, and a second clasp being placed over the wire after the last washer, the second clasp attaches to the second end of the wire. The second clasp might also attach to a second intermediate position of the wire, all of the spacers being fixedly attached the wire.

The present invention is used by first inserting the plunger of the cork extractor into the mouth of a bottle so that a broken cork is completely inserted within the bottle. Then, inserting the extracting element of the cork extractor within the bottle so that the extracting element lies beneath the cork. Lastly, slowly pulling the cork extractor upward so that the extracting element is made to slowly grasp the cork as the extractor is pulled upward. The cork will roll on the extractor as the cork is being pulled up until the last washer firmly grasps the cork, allowing the cork to be removed from the bottle.

### DRAWINGS

These and other features, aspects, and advantages of the present invention will become better understood with regard to the following description, appended claims, and drawings where:

FIG. 1 shows a perspective view of a cork extractor;

FIG. 2 shows another embodiment of the present invention in a first position; and

FIG. 3 shows the embodiment of FIG. 2 in a second position.

### DESCRIPTION

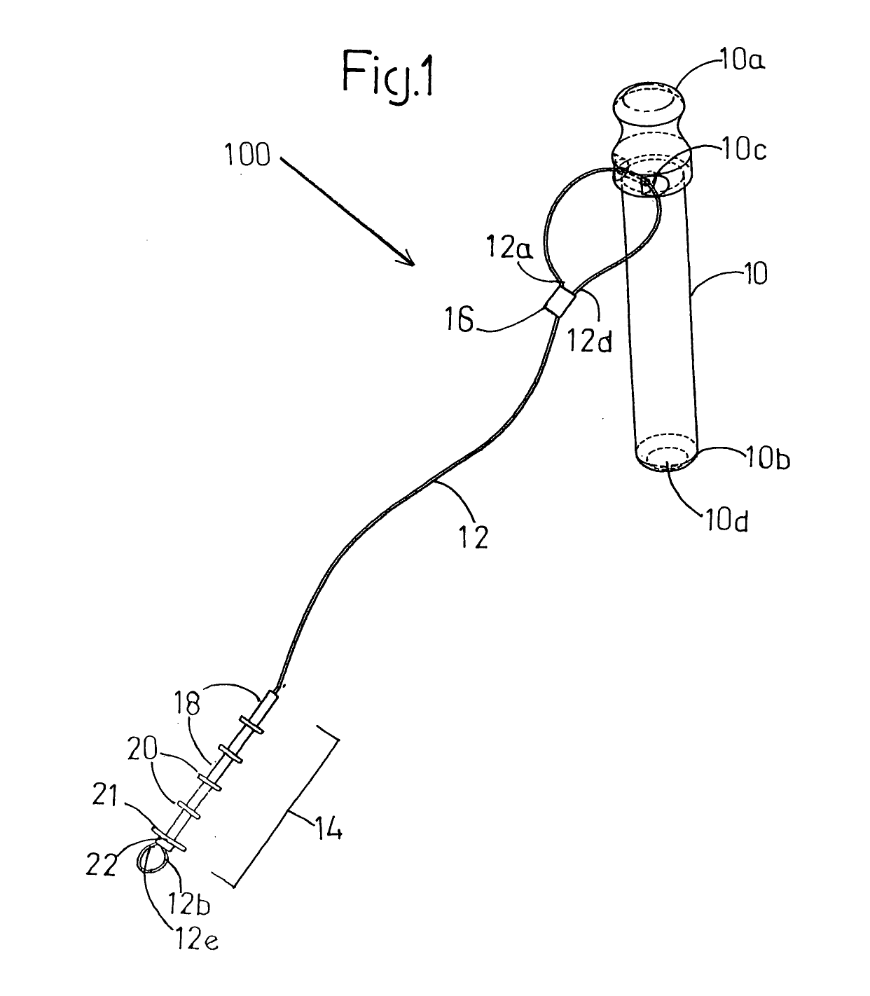

As seen in FIG. 1, a cork extractor 100 comprising a plunger 10, a wire 12 attached to the plunger 10 and an extracting element 14 attached to the wire 12.

The plunger 10 has a first 10a and a second end 10b, the plunger 10 defining an aperture 10c at an intermediate position substantially towards the first end of the plunger 10.

The wire 12 has a first 12a and a second end 12b, the first end of the wire 12a is placed through the aperture 10c of the plunger 10 and secured to the plunger 10 by attaching a first clasp 16 to the first end of the wire 12a. The first clasp 16 might also be attached to a first intermediate position of the wire 12d.

The extracting element 14 comprises a plurality of spacers 18 and a plurality of washers 20, wherein the spacers 18 and washers 20 are placed over the second end of the wire 12b so that the spacers 18 and washers 20 are in the following order, spacer 18 washer 20 spacer 18 washer 20 spacer 18 washer 20 and so forth, the last washer 21 placed over the second end of the wire 12b having a greater diameter than the other washers 20, and a second clasp 22 being placed over the wire 12 after the last washer 21, the second clasp 22 attaches to the second end of the wire 12b. The second clasp 22 might also be attached to a second intermediate position of the wire 12e. All of the spacers 18 are fixedly attached to the wire 12.

In another embodiment of the present invention, the plunger 10 defines a chamber 10d to house the extracting element 14.

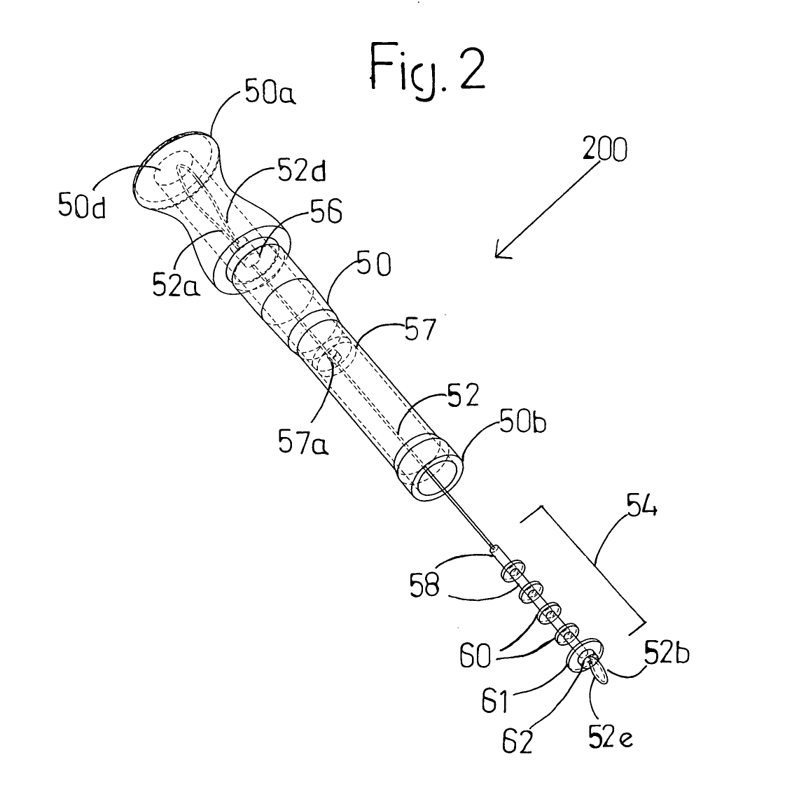

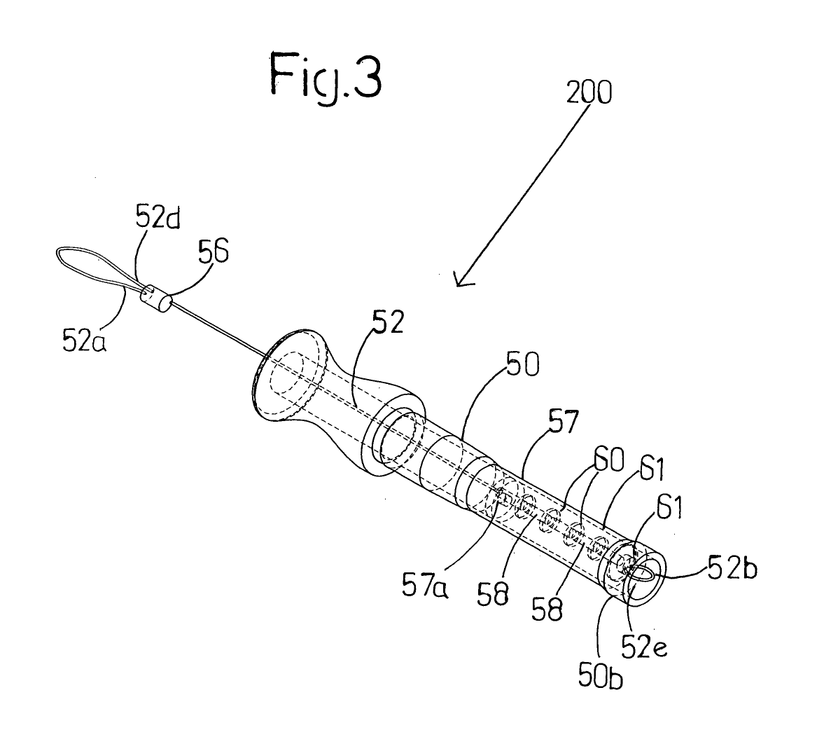

As seen in FIG. 2-3, a cork extractor 200 comprising a plunger 50, a wire 52 attached to the plunger 50 and an extracting element 54 attached to the wire 52.

The plunger 50 has a first 50a and a second end 50b, the plunger 50 defines a chamber 50d running through the plunger 50, and the plunger 50 comprises of a plunger washer 57 housed and fixedly attached to the plunger 50 at a position between the first and second end of the plunger 50, the plunger washer 57 defines a centrally positioned aperture 57a.

The wire 52 has a first 52a and a second end 52b, the first end of the wire 52a is placed through the aperture of the washer 57a and secured by attaching a first clasp 56 to the first end of the wire 52a. The first clasp might also attach to a first intermediate position 52d of the wire 52.

The extracting element 54 comprises a plurality of spacers 58 and a plurality of washers 60, wherein the spacers 58 and washers 60 are placed over the second end of the wire 52b so that the spacers 58 and washers 60 are in the following order, spacer 58 washer 60 spacer 58 washer 60 spacer 58 washer 60 and so forth, the last washer 61 placed over the second end 52b of the wire having a greater diameter than the other washers 60, and a second clasp 62 being placed over the wire 52 after the last washer 61, the second clasp 62 attaches to the second end of the wire 52b. The second clasp 62 might also attach to a second intermediate position of the wire 52e, all of the spacers 18 being fixedly attached the wire.

The cork extractor 100, 200 might be made of materials approved for use in the food and beverage industry.

An advantage of the present invention is that it allows a user to pull a damaged cork from within a bottle without leaving remnants within the bottle.

Another advantage of the present invention is that it allows a user of a damaged cork to push the cork within a wine bottle so that the cork can be removed without leaving remnants within the bottle.

A further advantage of the present invention is that it allows waiters not to fear opening a wine bottle.

Still a further advantage of the present invention is that it minimizes the costs associated with damaged bottles in the food and wine industry.

Although the present invention has been described in considerable detail with reference to certain preferred versions thereof, other versions are possible. Therefore the spirit and the scope of the claims should not be limited to the description of the preferred versions contained herein.

1. A cork extractor comprising:
a plunger, a wire operatively connected to the plunger; and a selectively vertically releasable extracting element adapted to extract remaining pieces of cork from inside a bottle, the extracting element is attached to the wire and the wire is partially housed within the plunger.

2. The cork extractor of claim 1, wherein the plunger has a first and a second end, the plunger defining an aperture at an intermediate position substantially towards the first end of the plunger.

3. The cork extractor of claim 2, wherein the wire has a first and a second end, the first end of the wire is placed through the aperture of the plunger and secured to the plunger by attaching a first clasp to the first end of the wire

4. The cork extractor of claim 3, wherein the extracting element comprises a plurality of spacers and a plurality of washers, wherein the spacers and washers are placed over the second end of the wire so that the spacers and washers are in the following order, spacer washer spacer washer spacer washer and so forth, the last washer placed over the second end of the wire having a greater diameter than the other washers, and a second clasp being placed over the wire after the last washer, the second clasp attaching to the second end of the wire, all of the spacers being fixedly attached the wire.

5. The cork extractor of claim 4, wherein the first clasp attaches to a first intermediate position of the wire and the second clasp attaches to a second intermediate position of the wire.

6. The cork extractor of claim 5, wherein the plunger defines a chamber to house the extracting element.

7. The cork extractor of claim 6, wherein the materials used to make the cork extractor are all materials approved for use in the food and beverage industry.

8. The cork extractor of claim 1, wherein the plunger has a first and a second end, the plunger defines a chamber running through the plunger, and the plunger comprises of a plunger washer housed and fixedly attached to the plunger at a position between the first and second end of the plunger, the plunger washer defines a centrally positioned aperture.

9. The cork extractor of claim 8, wherein the wire has a first and a second end, the first end of the wire is placed through the aperture of the washer and secured by attaching a first clasp to the first end of the wire.

10. The cork extractor of claim 9, wherein the extracting element comprises a plurality of spacers and a plurality of washers, wherein the spacers and washers are placed over the second end of the wire so that the spacers and washers are in the following order, spacer washer spacer washer spacer washer and so forth, the last washer placed over the second end of the wire having a greater diameter than the other washers, and a second clasp being placed over the wire after the last washer, the second clasp attaches to the second end of the wire, all of the spacers being fixedly attached the wire.

11. The cork extractor of claim 10, wherein the first clasp attaches to a first intermediate position of the wire and the second clasp attaches to a second intermediate position of the wire.

12. The cork extractor of claim 11, wherein the materials used to make the cork extractor are all materials approved for use in the food and beverage industry.

13. A cork extractor comprising:
a plunger, the plunger has a first and a second end, the plunger defining an aperture at an intermediate position substantially towards the first end of the plunger;
a wire, the wire has a first and a second end, the first end of the wire is placed through the aperture of the plunger and secured to the plunger by attaching a first clasp to the first end of the wire; and
a selectively vertically releasable extracting element adapted to extract remaining pieces of cork from inside a bottle, the extracting element is attached to the wire and the wire is partially housed within the plunger, the extracting element comprises a plurality of spacers and a plurality of washers, wherein the spacers and washers are placed over the second end of the wire so that the spacers and washers are in the following order, spacer washer spacer washer spacer washer and so forth, the last washer placed over the second end of the wire having a greater diameter than the other washers, and a second clasp being placed over the wire after the last washer, the second clasp attaches to the second end of the wire.

14. The cork extractor of claim 13, wherein the first clasp attaches to a first intermediate position of the wire and the second clasp attaches to a second intermediate position of the wire.

15. The cork extractor of claim 14, wherein the plunger defines a chamber to house the extracting element.

16. The cork extractor of claim 15, wherein the materials used to make the cork extractor are all materials approved for use in the food and beverage industry.

17. A cork extractor comprising:
a plunger, the plunger has a first and a second end, the plunger defines a chamber running through the plunger, and the plunger comprises of a plunger washer housed and fixedly attached to the plunger at a position between the first and second end of the plunger, the plunger washer defines a centrally positioned aperture;
a wire, the wire has a first and a second end, the first end of the wire is placed through the aperture of the washer and secured by attaching a first clasp to the first end of the wire; and
a selectively vertically releasable extracting element adapted to extract remaining pieces of cork from inside a bottle, the extracting element is attached to the wire and the wire is partially housed within the plunger, the extracting element comprises a plurality of spacers and a plurality of washers, wherein the spacers and washers are placed over the second end of the wire so that the spacers and washers are in the following order, spacer washer spacer washer spacer washer and so forth, the last washer placed over the second end of the wire having a greater diameter than the other washers, and a second clasp being placed over the wire after the last washer, the second clasp attaches to the second end of the wire.

18. The cork extractor of claim 17, wherein the first clasp attaches to a first intermediate position of the wire and the second clasp attaches to a second intermediate position of the wire.

19. The cork extractor of claim 18, wherein the materials used to make the cork extractor are all materials approved for use in the food and beverage industry.
